(19) United States
(12) Patent Application Publication
(10) Pub. No.: US 2009/0201001 A1
(43) Pub. Date: Aug. 13, 2009

(54) SAMPLED DATA ANALOG CIRCUITS FOR INTEGRATED COMPENSATION OF SWITCH MODE POWER SUPPLIES

(75) Inventors: Shanmuganand Chellamuthu, Richardson, TX (US); James R. Hellums, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/335,164

(22) Filed: Dec. 15, 2008

Related U.S. Application Data
(60) Provisional application No. 61/013,515, filed on Dec. 13, 2007.
(60) Provisional application No. 61/013,508, filed on Dec. 13, 2007.

(51) Int. Cl. G05F 1/10

(52) U.S. Cl. 323/282

(57) ABSTRACT

A switching mode power supply utilizing an analog sampled data system in the feedback control loop in which the coefficients of the sampled data system are change by reprogramming a programmable nonvolatile memory when external LC values vary.

### CROSS-REFERENCE TO RELATED APPLICATIONS

This application claims the benefit of application Ser. No. 61/013,515 filed Dec. 31, 2007 and application Ser. No. 61/013,508 filed Dec. 13, 2007, which are incorporated herein in their entirety by reference.

### BACKGROUND OF THE INVENTION

SMPS need compensation for stable operation. Compensation passives can be integrated on chip. But these values are good for a particular value of LC filter. Any inductor or capacitor variation will make the system unstable. The only other method is to overdamp the system but will lead to poor transient response. This novel idea allows changing the integrated compensation parameters to account for the external passives variation or different LC filter values.

### SUMMARY OF THE INVENTION

Compensation passives are replaced by Analog sampled data circuits. The analog sampled data system coefficients can be changed using some type of non-volatile memory such as EEPROM. The proposed solution can independently change the compensation poles and zeros. Any changes in external inductor and capacitor can be accommodated by changing the poles and zeros. By this method the system is stable and fast transient response can still be achieved.

### BRIEF DESCRIPTION OF THE DRAWINGS

FIG. 1 is a schematic block diagram of a prior art switched mode power supply;

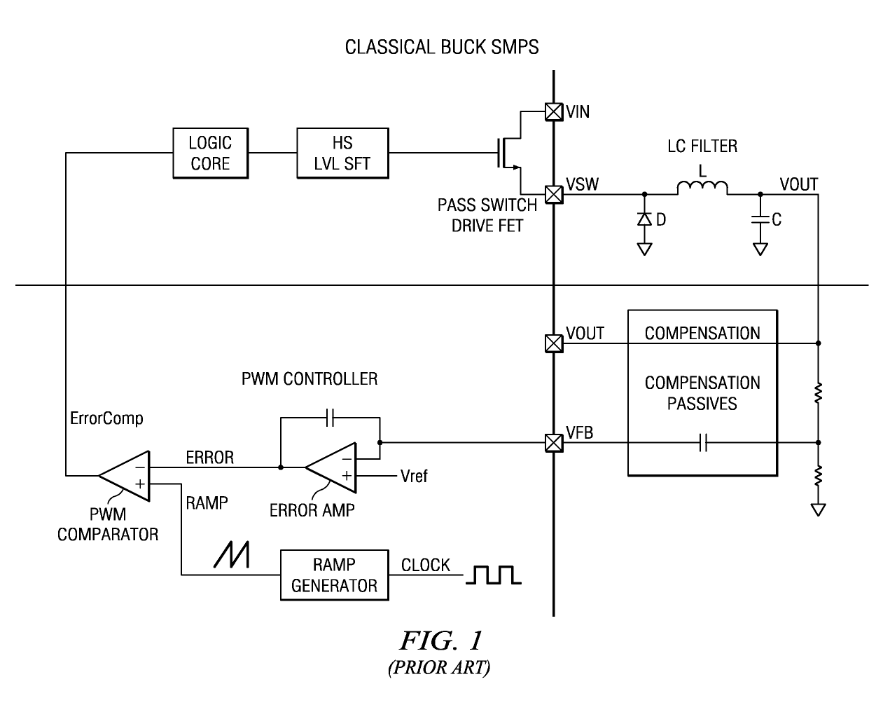

FIG. 2 is a schematic block diagram of a second prior art switched mode power supply;

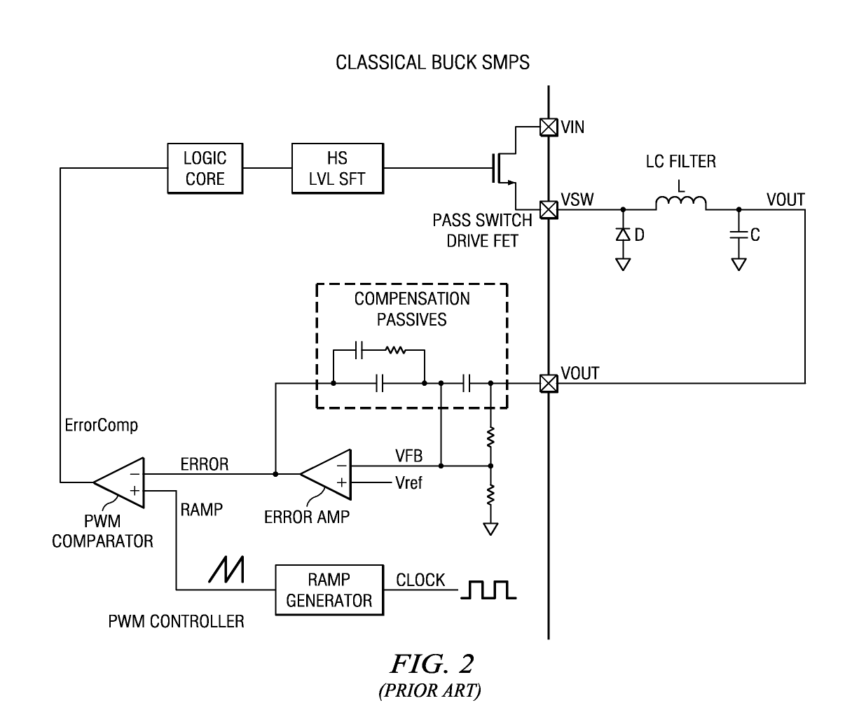

FIG. 3 is a schematic block diagram of a switched mode power supply according to the present invention; and

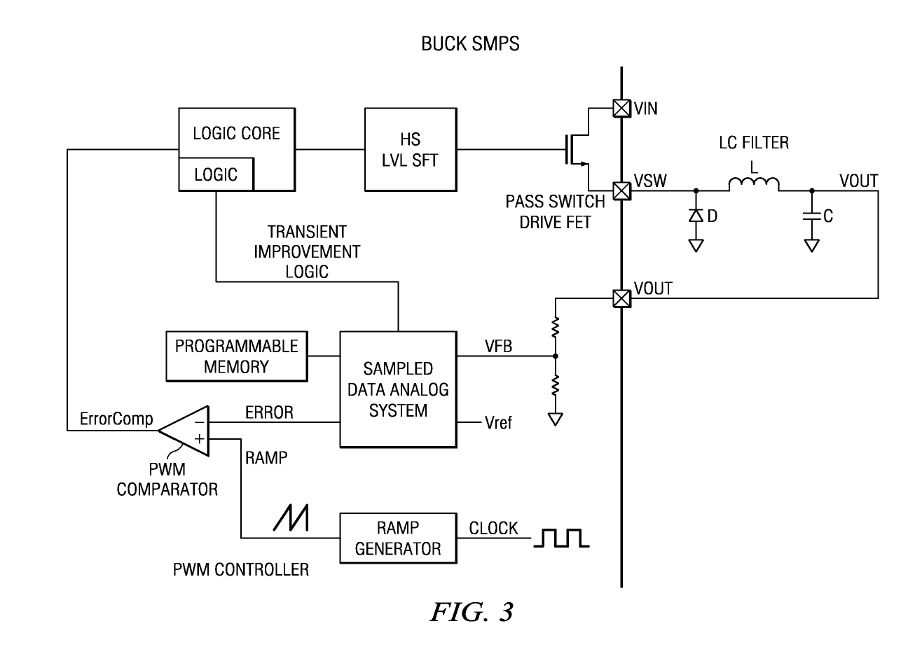

FIG. 4 shows the second part of the transfer function.

### DETAILED DESCRIPTION

Traditionally, the compensation parameters are individually adjusted to make the system stable. Recent trend is use DSP's and digitally control the feed back loop. This novel method uses analog sampled data system circuits to replace the traditional feedback loop. This also allows the coefficients of the sampled—data system to be changed to account for external passive variation.

Analog sampled data systems can be produced on the same substrate unlike DSP's. So they are much cheaper and can be integrated on the same substrate as power FETs. They are also smaller as it does not need much overhead like DSP's. They are very versatile in changing the poles and zeros and can be individually changed unlike traditional compensation. Since they are sample data systems, because of their discrete operation they have very low power consumption.

Classical method of Compensation is outside the chip and is not integrated. The compensation passive values are chosen based on the external LC filter value.

This is an improvement to prior art 1. The compensation passives are integrated inside the chip to save board area. When the external LC values vary, the system become unstable.

This is an improvement to prior art 2. The compensation passives are integrated inside the chip to save board area. When the external LC values vary, the coefficients of the sampled data systems are changed by re-programming the programmable non-violatile memory.

Example of a continuous time transfer function of compensation network (prior art 2).

$$\frac{Vout ( s )}{Vin ( s )} = \frac{1}{s ( 7.13 {e}^{11}} \frac{{s}^{2} ( 6.75 {e}^{11} ) s ( 1.69 {e}^{5} ) 1}{{s}^{2} ( 1.43 {e}^{8} ) s ( 1.07 {e}^{1} ) 2 {e}^{5}}$$

Discrete time transfer function equivalent of above compensation network

$$\frac{Vout ( z )}{Vin ( z )} 0.7864 \frac{z 0.9888}{z 1} \frac{{z}^{2} 1.9866 z 0.9866}{{z}^{2} 1.5253 z 0.5816}$$

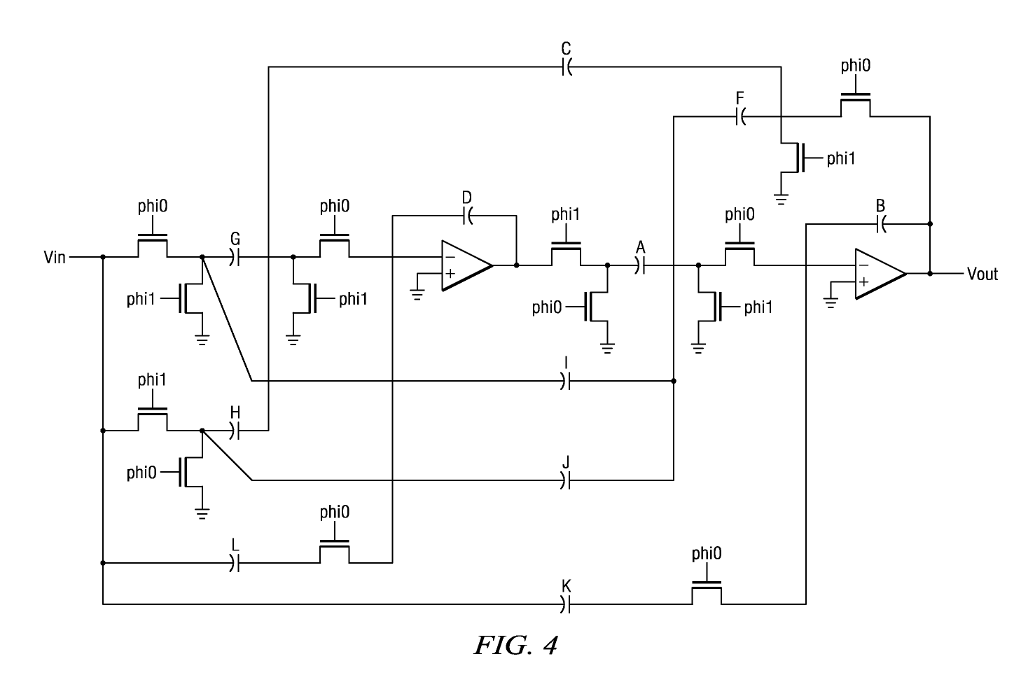

The first part of transfer function is a simple first order implementation. The second part is realized as a biquad and is as shown in FIG. 4.

$$\frac{Vout ( z )}{Vin ( z )} \frac{\underline{\frac{\hat{I}}{1 F} 1 \frac{\hat{I} \hat{J} \hat{G}}{\hat{I}} {z}^{1} \frac{\hat{J} \hat{H}}{\hat{I}} {z}^{2}}}{1 \; 2 \frac{2 F + C}{2 ( 1 F )} {z}^{1} \frac{1}{1 F} {z}^{2}}$$

When A=B=D=1 and I=I+K, G−G+L, H=H+L, J=J+K

The poles are zeros can be individually changed which gives this architecture the best versatility.

1. A sampled data analog circuit for integrated compensation of switched mode power supplies substantially as shown and described.
